(19) United States
(12) Patent Application Publication
(10) Pub. No.: US 2005/0192870 A1
(43) Pub. Date: Sep. 1, 2005

(54) Method and system for providing an intelligent goal-oriented user interface to data and services

(75) Inventor: Norman D. Geddes, Cumming, GA (US)

Correspondence Address: KILPATRICK STOCKTON LLP, 607 14TH STREET, N.W., WASHINGTON, DC, 20005, US

(73) Assignee: Applied Systems Intelligence, Inc.

(21) Appl. No.: 11/048,019

(22) Filed: Feb. 2, 2005

Related U.S. Application Data
(63) Continuation of application No. 09/598,240, filed on Jun. 21, 2000.

(51) Int. Cl. G06F 17/60

(52) U.S. Cl. 705/26

(57) ABSTRACT

A buyer agent system is disclosed for assisting purchasers to retrieve data, obtain services, and purchase products on a computer network. One embodiment identifies a purchaser's goal and then uses a knowledge base to create a plan for meeting the determined goal. The system uses an inference engine such as a partial order planner, or a non-monotonic truth maintenance system to create plans. One embodiment of the present invention is an Internet browser plug-in for assisting purchasers in conducting electronic commerce.

### CROSS REFERENCE TO RELATED APPLICATIONS

This application is a continuation of prior application Ser. No. 09/598,240, filed Jun. 21, 2000, which application is hereby incorporated herein by reference.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

1. Field of the Invention

The invention relates to a software purchasing agent that assists users in retrieving information, obtaining services, and purchasing products across a network. More particularly, the present invention relates to an intelligent agent that identifies the preferences and intentions of purchasers as individuals to provide a personalized interface to data and services on a network such as the Internet.

2. Background Information

The growth of electronic commerce is staggering. According to a recent federal government report, purchasers spent more than $6 billion in on-line sales during the 1999 holiday season. By the year 2003, annual electronic commerce expenditures are expected to exceed $1.4 trillion. As electronic commerce on the Internet grows, purchasers are finding themselves inundated with data. By the end of 1999, there were an estimated 500 million web pages available on the Internet with over 1 million new pages being added every day. In order to manage the data, there is a need for an intelligent agent to assist users in obtaining data and services on the Internet.

While the World-Wide Web (the “Web”) was still in its infancy, users quickly realized the need for resources to deal with the growing amount of information available. Sites such as Yahoo™ and Lycos™ were developed to catalogue and index the available data so that users could have some assistance in finding information that was needed. However, as the Web continues to grow, these tools are proving insufficient in meeting the needs of users; many useful sites are not catalogued and index searches often return so many links that a user can not read them all to find the most useful resources.

Many companies have realized that more useful tools are needed, and several rudimentary systems have been developed to assist purchasers in making purchases on the Internet. For example, Amazon.com™ provides a feature to assist purchasers in finding products that interest them. The system generates a list of merchandise that a user has purchased and the user is given the option to rate each one. Using this list of ratings, Amazon.com™ presents a list of recommendations based on the purchases of other customers with similar ratings.

In addition, other shopping agents exist that collect pricing information from various Internet merchants to provide a portal for comparison shopping. For example, mySimon™ provides a portal to search for products being sold by on-line merchants and on on-line auctions. This system uses intelligent agents to collect information from over 2000 stores on the Internet and consolidate that information into a searchable portal that makes it easy for customers to find the cheapest place to obtain a product. Using the mySimon™ web site, a user can specify an individual product or product line (e.g., a Sony™ cordless telephone). The mySimon™ search engine then displays a price, description, and the availability of matching products from various on-line merchants.

Despite many benefits, available purchaser agents on sites provide little more than rudimentary data mining capabilities. They allow simple aggregations that provide purchasers with the ability to find the cheapest price or to find products that others with similar buying habits have purchased. The designs of these systems are too simple to capture the complexity of real world purchaser desires and intentions.

Several patents disclosing agent software have been issued by the U.S. Patent and Trademark Office. For example, U.S. Pat. No. 5,732,398 to Tagawa discloses a self-service system for selling travel related services or products. However, this system is not goal-oriented and does not use a planner to provide an intelligent decision support system.

Additionally, U.S. Pat. No. 6,026,375 to Hall et al. (the '375 patent) discloses a system whereby a mobile customer and a service provider use intelligent agents to facilitate transactions. The '375 patent provides a database for storing the preferences of a particular mobile user. Using these preferences, the system provides a mechanism to allow a customer to place an order for products or services using a mobile device. The system determines the location of the user and estimates the user's time of arrival. This allows the service provider to more accurately schedule the fulfillment of the user's request, resulting in more efficient service with fewer customer delays.

Finally, U.S. Pat. No. 5,706,406 to Pollock (the '406 patent) discloses a method, useful as an on-line assistant, for analyzing data input, reasoning to conclusions based on the data, and adopting and executing plans based on the conclusions. The '406 patent discloses a more traditional expert system that can be used for numerous applications including manufacturing and robotics. Though the system uses a defeasible planning system, it does not provide a mechanism for intent interpretation and partial-order planning used to provide the intelligent agents of the present invention.

New intelligent agents are needed for assisting purchasers in retrieving data, obtaining services, and purchasing products on the Internet. There is a need for intelligent agents that can model purchaser intentions and desires with finer granularity and increased robustness and use this model to serve as an effective purchasing assistant, helping purchasers effectively and efficiently carry out a desired intent.

A challenging problem for the Internet as a commerce medium is to provide a similar level of problem-solving advice to the customer that has been provided by knowledgeable sales personnel. Often the purchaser has a need or a goal, but does not know what products or set of steps is needed to satisfy the goal. There is a need for an intelligent agent that can build plans to assist purchasers in carrying out intentions or reaching goals, where the plans may include choices for products or services, along with information about their use.

### SUMMARY OF THE INVENTION

In accordance with the invention, there is provided a method for assisting a purchaser in conducting electronic commerce on a computer network. The method includes determining a goal for a purchaser and using a knowledge base to create a plan for achieving the goal. The knowledge base used to create a plan includes expert knowledge for one or more domains. In a more specific embodiment, the plan is associated with a list of items necessary to carry out the determined goal. Additional embodiments use a partial order planner and a non-monotonic truth maintenance system to assist in creating plans. Additional embodiments specify a knowledge base containing data stored as a plan and goal graphs and/or concept graphs.

Additionally, a buyer agent for conducting electronic commerce across a computer network is presented in accordance with the present invention. The buyer agent includes a knowledge base and an inference engine that uses the knowledge base to create plans for conducting electronic commerce. Other embodiments of the buyer agent system use a knowledge base including one or more plan goal graphs, one or more concept graphs, or one or more scripts including a sequence of partially-specified primitive actions. Further embodiments of the present invention use inference engines including a partial order planner, and a non-monotonic truth maintenance system.

Additional embodiments of the buyer agent system are implemented as an Internet web browser plug-in. One embodiment includes a monitoring component for recording the actions of a user within the Internet web browser. These actions can then be used to create a plan for conducting electronic commerce.

### BRIEF DESCRIPTION OF THE DRAWINGS

The present invention is further described in the detailed description which follows, by reference to a plurality of drawings by way of non-limiting examples of illustrated embodiments of the present invention, in which like reference numerals represent similar parts throughout the several drawings, and wherein:

FIG. 1 depicts a system according to one embodiment of the present invention;

FIG. 2 depicts a block diagram of the server architecture according to one embodiment of the present invention;

FIG. 3 is a flowchart for a method for assisting a user in conducting electronic commerce according to one embodiment of the present invention;

FIG. 4 depicts a block diagram of client and server systems according to one embodiment of the present invention;

FIG. 5 depicts a flowchart according to one embodiment of the present invention;

FIG. 6 is a block diagramming describing the life cycle of a plan maintained by a planner according to one embodiment of the present invention;

FIG. 7 illustrates a portion of a concept graph according to one embodiment of the present invention;

FIG. 8 illustrates a portion of a plan-goal graph (PGG) according to one embodiment of the present invention;

FIG. 9 describes a goal instance created by an intent interpreter according to one embodiment of the present invention; and

FIG. 10 depicts a portion of a plan-goal graph (PGG) illustrating the operation of a planner selecting plans to achieve goals according to one embodiment of the present invention.

### GLOSSARY

Concept Graph: a knowledge representation of the dependencies between observable data values and higher-level computations and assertions made about the data. A concept graph can be implemented as a directed acyclic graph of concept nodes that is a particular type of augmented transition network (ATN).

Expert System: a computer program that uses a knowledge base to assist in solving problems. Most expert systems use an inference engine to derive new facts and beliefs using a knowledge base.

Full-Order Planner: (also called a total-order planner) a process that computes a fully-ordered list of primitive steps or actions to reach a goal, in which each step or action is fully definitized at the completion of the planning process.

Inference Engine: a computer program that infers new facts or beliefs from known facts or beliefs using a knowledge base and a set of logical operations.

Intent Interpreter: an expert system that uses a knowledge base to determine the present intention of a user or a system.

Knowledge Base: a collection of knowledge (e.g., objects, concepts, relationships, facts, rules, etc.) expressed in a manner such that it can be used by an inference engine. For example, a knowledge base may include rules and facts or assertions as in traditional expert systems.

Least Commitment Planner: a process that generates a plan that avoids making a choice between two or more alternative courses of action unless it is necessary to do so. A least commitment planner avoids definitizing any particular sub-element of a plan beyond the minimum necessary to determine likely success. Final definitization of the primitive steps is deferred until just prior to the execution of each plan sub-element by a plan execution agent.

Primitive step. a representation of an activity that is not further decomposed by a planner. Also called a primitive action.

Partial-Order Planner: a process that generates a partially ordered set of activities at the completion of the planning process.

Plan. a abstract representation of a set of activities to be performed from the present into the future. A plan may be decomposable into plan sub-elements that define more detailed activities. The lowest level of decomposition of a plan is a primitive step or action.

Plan Execution Agent. a process that directly operates on the environment by performing activities represented by a plan.

Plan-Goal Graph (PGG): a knowledge representation for expressing causal relationships in an operational domain as well as the intentions of a user. A PGG can be expressed as an acyclic, directed graph where plans are decomposed into subgoals or primitive actions.

Planner: a computer program that determines a sequence of operations or actions to be taken to reach one or more goals.

### DETAILED DESCRIPTION OF THE ILLUSTRATED EMBODIMENTS

A detailed description of the present invention is presented first by describing several representative embodiments. Then, various generalized methods of implementing an intelligent agent to assist purchasers according to the present invention are described. The invention applies to a full range of buying activities for goods and/or services. The invention is not limited to the representative embodiments. A person of ordinary skill in the art could apply the invention to a wide variety of purchases, auctions, and reverse auctions.

The various embodiments of the present invention improve on traditional artificial techniques. One of ordinary skill in the art may find the following references helpful in providing appropriate background understanding in the design and construction of inference engines, knowledge bases, and various knowledge representations used by the present invention: (1) Schank, R. C. and Abelson, R., Scripts, Plans Goals and Understanding, Hillsdale, N.J.: Lawrence Erlbaum Associates (1977); (2) Schank, R. C. and Riesbeck, C. K., Inside Computer Understanding. Hillsdale, N.J.: Lawrence Erlbaum Associates (1981); (3) Sacerdoti, E. D., A Structure for Plans and Behaviors, New York: Elsevier (1978); (4) Rinnooy Kan, A. H. G., Machine Scheduling Problems. The Hague: Martinus Nijhoff (1976); and (5) Charniak, E, Riesbeck, C. K. and McDermott, D., Artificial Intelligence Programming. Hillsdale, N.J.: Lawrence Erlbaum Associates (1980).

The first embodiment of the present invention is a server-based intelligent agent embodied as a web portal for purchasing supplies for home improvement projects. Traditional electronic commerce web sites take a conventional catalogue approach to selling merchandise—they present a list of products that are offered for sale and provide descriptions of those products. Such web sites can be relatively inexpensive to implement and provide minimal functionality necessary to complete purchases over the Internet. The first embodiment of the present invention improves this model.

Instead of asking users “What would you like to buy?”, the first embodiment of the present invention asks users “What are you trying to accomplish?” Then, using domain knowledge, the system is able to assist the user in determining what he or she needs to buy to accomplish a goal.

In this embodiment, the system queries a user to determine a desired home improvement project. The user is given many options to choose from including such options as building a deck, remodeling a kitchen, remodeling a bath, etc. Once the user has selected an option, this embodiment uses domain knowledge about the particular home improvement project and information about the customer's home and environment to refine a shopping list of products necessary to complete the desired task.

For example, if a user selects the option “Build Deck”, then the system consults its knowledge base and begins asking the user questions to determine the size, location, and design features of the planned deck. The resulting plan that is generated by the buyer agent includes a comprehensive list of components and/or services that need to be purchased or considered in order to build the deck. Alternatively, the list may be limited to pertinent goods and services available through that portal (or vendor). A detailed description of the design and implementation of this embodiment follows.

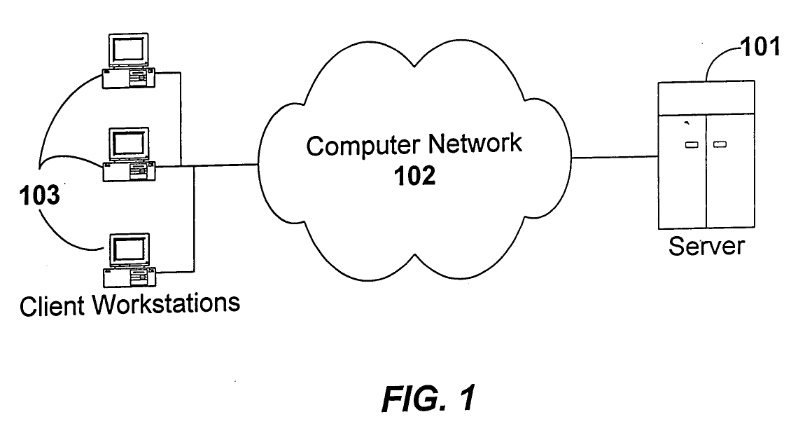

The home improvement embodiment of the present invention is implemented as shown in FIG. 1. Server 101 is a computer that can process data from a client and provide data to the client. In a preferred embodiment, server 101 is an Intel™-based computer system running the Microsoft Windows 2000™ operating system. Server 101 is connected to a computer network 102 by a network interface. In this example, the computer network 102 is the Internet. Server 101 hosts the software applications described below, providing services to client systems 103 across the computer network 102. The client systems 103 are embodied as any computing device with a web browser. For example, client systems 103 can include general purpose computing devices, web-enabled cell phones, personal digital assistants (PDAs), WebTV™ devices, or any other device capable of accessing computer network 102.

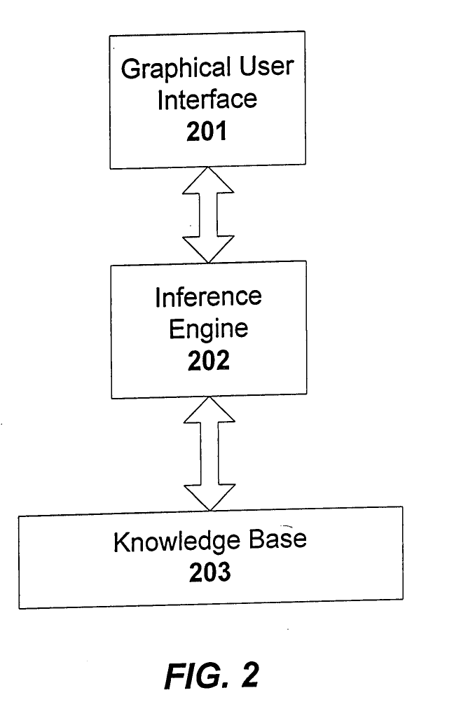

FIG. 2 shows some of the details of the software architecture in accordance with a preferred embodiment. As discussed above, Server 101 runs the Microsoft Windows 2000™ operating system. On top of the operating system, the primary interface to end users is a web server application such as the Microsoft Internet Information Server™ (IIS). The present embodiment is implemented using Java™ and Active Server Pages™ (ASPs) served by the IIS server. The software uses a Microsoft™ Access™ database to store data used by the invention.

Next, we turn our attention to the software architecture underlying the present invention as shown in FIG. 2. In this embodiment of the present invention, an inference engine 202 uses relationships and assertions stored in knowledge base 203 to create plans. Interaction with the user is implemented by a graphical user interface 201. In the first embodiment, inference engine 202 is a conventional inference engine of the kind typically used in artificial intelligence applications.

Knowledge base 203 stores relationships and assertions necessary to create plans. For example, in the home improvement embodiment of the present invention, the knowledge base stores relationships and assertions related to home improvement projects. For example, knowledge base 203 may store relationships regarding dependencies between different products that may be purchased for home improvement projects. For instance, Teflon™ tape may be needed to install a shower head. If a relationship to that effect is in knowledge base 203, then the system will suggest that a purchaser consider buying Teflon™ tape whenever the purchaser accepts a plan to install a shower head.

Interaction with the user is performed using graphical user interface 201. In this embodiment of the present invention, graphical user interface 201 is implemented as a conventional Java™ servlet.

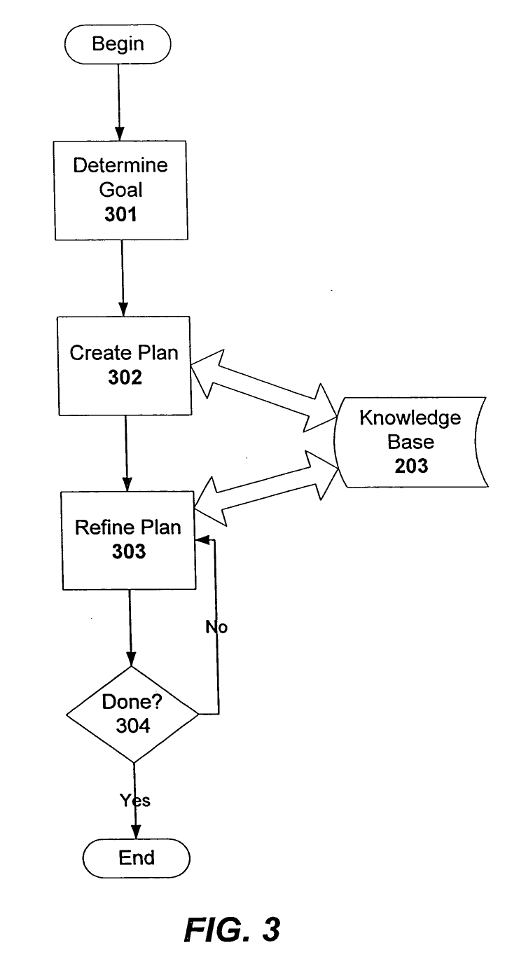

Operation of the first embodiment of the present invention is shown by FIG. 3. The process begins in block 301 by determining one or more goals for a user. In the first embodiment, goals are initially determined by giving the user a list of potential home improvement projects. The user selects one or more projects from the list to identify the user's ultimate goal or goals. In later embodiments, described below, the system interprets the intentions of a user in order to identify goals.

Once a goal has been identified, the system uses an inference engine to create a plan for achievement of that goal as shown in block 302. The inference engine uses relationships and assertions stored in knowledge base 203 to perform conventional planning techniques to create a plan for achievement of the goal determined in block 301.

The plan can then be successively refined in block 303 until the plan is complete. If the plan is not complete, as determined in block 304, the system further refines the plan in block 303. During plan refinement, the system may solicit user inputs that further define the situation and intentions of the user that are relevant to the planning process. Further refinement of identified plans continues until the plan is complete.

In the first embodiment, users select a home improvement project from a list of home improvement projects within the system's domain knowledge. This determines the goal in block 301. The system then determines what materials, tools, and supplies are necessary to complete the home improvement project in block 302. At this point, the system queries the user for any additional information that is necessary to complete the plan. For example, if the plan includes recessed lighting, the system will query the purchaser as to whether the space above the ceiling where the lights will be installed is accessible. Additionally, the system will ask the purchaser whether insulation will be in contact with the light's housing. Once all questions are answered, the system generates a list or shopping cart containing the necessary supplies for completing the project.

As an additional refinement, the system may display various aspects of the plan that has been constructed. The consumer could ask about the plan and make modifications as appropriate. After changes are made to the plan, a new list or shopping cart would be generated.

At this point, a user can refine the list or shopping cart. For example, the user may already have the necessary tools for performing the desired tasks or may desire to procure an item or service elsewhere. In that case, the user can remove the tools from the list or shopping cart. The user may also refine the plan by adding additional lights or changing the type of lights to be used. For example, the user may prefer low-voltage halogen lights instead of conventional recessed lighting. After all refinements have been completed, the user is left with a list or shopping cart containing all materials, tools, and supplies desired by a purchaser to implement a home improvement project.

In one embodiment of the present invention, a user can purchase the merchandise identified in the shopping cart using conventional methods for completing orders on a computer network. Additionally, any other purchasing model for conducting electronic commerce can be used with the present invention. For example, a conventional auction system can be used wherein a consumer determines one or more goods and/or services from the list or shopping cart. Vendors can bid on the cost the user must pay to obtain those goods. The vendor with the lowest bid wins the auction and supplies the identified merchandise at that price.

In an additional embodiment, a reverse auction purchasing model is used wherein a purchaser determines one or more desired goods and/or services from the list or shopping cart and specifies the desired price. Vendors are informed of the price and given the opportunity to provide the goods or services for that price. Alternative embodiments of the present invention use various combinations of auctions, reverse auctions, and purchases.

One of ordinary skill in the art will appreciate that there are many variations of the software and hardware configuration described. For example, server 101 could be embodied as a Unix™ platform using Hewlett Packard™, Sun Microsystems™, or Intel™-based computers.

Additionally, one of ordinary skill in the art will appreciate that this first embodiment just described can be used in any electronic commerce domain. This is done by encoding knowledge about the domain into knowledge base 203 and by creating a graphical user interface to provide the appropriate user interaction. For example, a web site could be set up to assist users in starting up a new business. Domain knowledge is encoded in the same manner as conventional knowledge-based systems. Experts in the field are interviewed (or reference works, surveys, reports, or publications are consulted) to assist in encoding the domain knowledge. For example, the system may include knowledge about business license requirements, taxation issues, real estate contacts, attorneys, etc. The system could assist an entrepreneur in starting a business by identifying products and services that he or she may need as well as identifying the actions that must be taken.

The next embodiment of the present invention improves on the first by retaining information about users' prior visits. This adds valuable feedback to the system. It would also means that the user does not have to enter as much data on subsequent visits. Information about a user's purchases and intentions are retained by the system. When the same user accesses the home improvement system for the next project, the system uses this information to better refine plans given that user's history.

Consider the following example. A few months ago, the user accessed the home improvement system and chose an option to install a ceiling fan. The system used its knowledge base to determine the tools and parts that the user needed. The user used the home improvement system to purchase the tools and supplies in a reverse auction. Now, the user is ready for the next project—a home security system. This embodiment of the present invention knows that the user already has a drill and other tools necessary to complete the job and so it can either exclude them from the shopping cart or query the user before including those tools.

Additionally, the system determines when a customer has previously used particular brands or supplies. If a customer has previously used a particular brand or a particular product, the system looks at its knowledge base to see if the customer has previously stated a preference or evaluation regarding the product or brand. If not, then the system can request feedback from the user. If so, that preference is used to build the resulting plan; otherwise, the user is queried about his or her preferences and the answers are stored to refine the customer's profile for future use.

The third embodiment of the present invention provides many additional features. The first and second embodiments discussed above provide a proactive interface that consults with a user to identify products and services desired to complete a task. The third embodiment takes a more passive approach, serving more as an assistant that occasionally reacts rather than a consultant to go to for a solution to a problem.

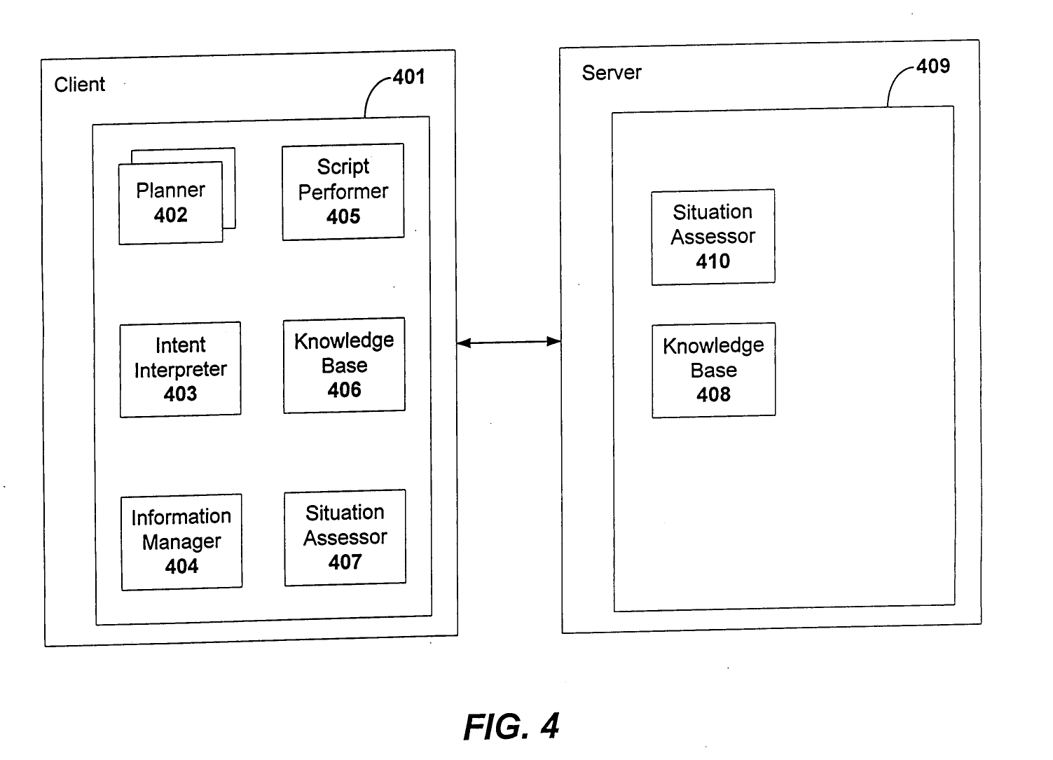

Decision support software has been used in other areas such as for the operation of complex military systems. The third embodiment applies and expands advanced decision support concepts to create an intelligent agent to assist purchasers in conducting electronic commerce. One embodiment of the present invention building on intelligent computer-aided interface technology is a travel planning system as shown in FIG. 4.

The first embodiment of the travel planning system is implemented using a client-server architecture analogous to that shown in FIG. 1. The travel planning system is implemented using the same hardware and network configuration as shown in FIG. 1 and discussed above; however, the software implementation differs. FIG. 4 shows an overview of the software architecture according to one embodiment of the present invention.

In the travel planning embodiment of the present invention, server 101 contains a server application 409 implemented as a Java™ servlet. In the first configuration, the server application 409 includes two components, a shared knowledge base 408 that stores scripts, plans, assertions, and other domain knowledge related to travel planning; and a situation assessor 410 that maintains the consistency of shared knowledge base 408, as well as providing knowledge to and receiving knowledge from clients.

The travel planning embodiment also includes a client application 401. In the first configuration, the client application 401 is implemented as a plug-in to a Netscape™ or Microsoft™ web browser. The client application 401 includes the following five components, each of which will be described in further detail below: (1) one or more planners 402; (2) an intent interpreter 403; (3) a script performer 405; (4) an information manager 404; (5) a knowledge base 406, and (6) a situation assessor 407. Each of these components is described in more detail below. In addition, the following publications describing various exemplary implementations of the constituent components of an inference engine are hereby incorporated by reference: (1) Hoshstrasser, Belinda Hardman and Normnan D. Geddes. Proceedings of the International Joint Conferences on Artificial Intelligence 1989 Workshop on Integrated Human-Machine Intelligence in Aerospace Systems. OPAL: Operator Intent Inferencing for Intelligent Operator Support Systems. (Aug. 21, 1989); (2) Geddes, Norman D., et al. Fostering Collaboration in System of Systems; (3) Rouse, William B., et al. An Architecture for Intelligent Interfaces: Outline of an Approach to Supporting Operators of Complex Systems. Human-Computer Interaction, vol. 3, pp. 87-122 (1987); (4) Geddes, Norman D. and Mark A. Hoffman. Supervising Unmanned Roving Vehicles Through an Intelligent Interface; (5) Geddes, Norman D., et al. Automated Acquisition of Information Requirements for an Intelligent Display; (6) Miller, Christopher A., et al. Plan-Based Information Requirements: Automated Knowledge Acquisition to Support Information Management in an Intelligent Pilot-Vehicle Interface. Digital Avionics Systems Conference (Seattle, Wash., Oct. 5-9, 1992); (7) Geddes, Norman D., Large Scale Models of Cooperative and Hostile Intentions. IEEE Computer Society, International Conference and Workshop on Engineering of Computer Based Systems (ECBS'97) (Monterey, Calif., Mar. 27-28, 1997); (8) Webb, Barry W., Norman D. Geddes, and Leslie O. Neste. Information Management with a Hierarchical Display Generator; (9) Rouse, W. B., N. D. Geddes, and J. M. Hammer. Computer-aided fighter pilots. IEEE Spectrum. pp. 38-41 (March 1990); (10) Geddes, N. D. and R. J. Lee. Intelligent Control for Automated Vehicles: A Decision Aiding Method for Coordination of Multiple Uninhabited Tactical Aircraft. Association for Unmanned Vehicle Systems International A UVSI'98 25th Annual Symposium and Exhibition. (Huntsville, Ala., Jun. 8-12, 1998); (11) Geddes, N. D., R. J. Lee, and J. L. Brown. A Portable Lightweight Associate for Urban Helicopter Pilotage. Submitted to IEEE (Sep. 25, 1997); and (13) Geddes, N. D. “Associate Systems: A framework for human-computer cooperation.” 7th International Conference of Human-Computer Interaction. (San Francisco, Calif., Aug. 24-29, 1997).

First, we discuss the planners 402. Any conventional planner could be used with the present invention; however, the preferred embodiment uses a real-time, partial-order, least-commitment planner. Such a planner is able to effectively deal with real-time operation in a changing world. During the travel planning process, customers will often change their minds about dates, times, locations, etc. If the system also fully determined an optimal plan, the system would waste computing cycles. A system that only plans as far as necessary for given constraints conserves resources by preventing excessive planning in a dynamic environment where preferences, goals, and intentions are frequently changing.

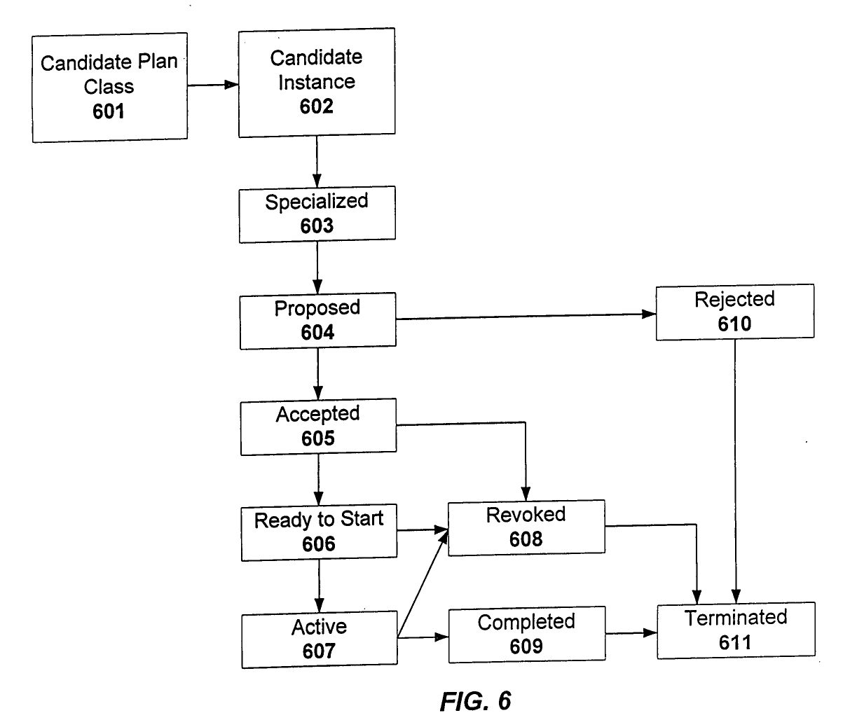

In this embodiment of the present invention, the planner 402 is a partial order planner and manages its level of commitment to the activities in the plan by using a state transition method to set the life cycle states of plan sub-elements. One embodiment of the plan life cycle state transitions is shown in FIG. 6. As a plan sub-element moves through its life cycle states from candidate towards the active state, the partial order planner is increasing its commitment to that plan sub-element. The partial order planner may also reduce its commitment by changing the plan sub-element state to rejected state or revoked state and ultimately to a terminated state. This mechanism provides a non-monotonic, graded level of commitment for each plan sub-element.

In one embodiment of the present invention, state transitions of the plan sub-elements are performed by the planner 402 in response to event signals received from the situation assessor 407. When the planner 402 moves a plan sub-element to a new life cycle state, the planner 402 requests the activation of specific monitors within situation assessor 407. In one embodiment of the present invention, the monitors represent the conditions under which a plan sub-element should be transitioned to a different one of its plurality of life cycle states. The situation assessor 407 periodically evaluates the specific monitors that have been activated, and provides an event signal to the planner 402 for each specific monitor whose conditions are satisfied.

One of the more interesting components of the travel planning embodiment of the present invention is intent interpreter 403. In order to create an effective semi-passive assistant, the system must monitor a user's actions to determine when the user is seeking information, services, or products within realm of the assistant's domain knowledge. The intent interpreter does this using a task-analytic decomposition of the purposes of users within a domain. This decomposition is represented as a plan goal graph (PGG), an acyclic, directed graph that represents the hierarchy of possible goals that may be pursued to achieve a mission and the methods (or plans) that can be used to satisfy each goal. Additionally, intent interpreter 403 uses knowledge represented as scripts. These scripts are sequences of partially-specified primitive actions whose execution may be dependent on the state of the execution context. Scripts represent standard procedures or business processes that are routinely used to perform specific domain-related activities described by plan sub-elements. Such standard business procedures may include standard means for making travel reservations, purchasing a variety of travel-related services, or requesting special travel requirements, such as handicapped assistance or special meals. The intent interpreter 403 uses reasoning on the PGG to represent problem solving behaviors that are necessary when existing business processes defined by scripts are not appropriate for the situation. Using assertions made by the other components of the system together with domain knowledge stored in knowledge base 406, the intent interpreter determines the most likely intent of a customer. This determined intent is then used to generate a plan for the customer.

One embodiment of the present invention uses an intent interpreter similar to that described by B. H. Hoshstrasser and N. D. Geddes in a paper entitled “OPAL: Operater Intent Inferencing for Intelligent Operator Support Systems” published July 1989. The intent interpreter includes a model of operator intent expressed as both scripts and plan-goal graphs. The system tries to understand operator actions in terms of its current model of operator intent. An action is said to be “explained” if it is consistent with what was expected by the intent model.

The intent interpreter first tries to interpret the intent of an operator action using script-based reasoning. This is equivalent to evaluating the user's behavior in the context of existing active standard business procedures of the domain, such as travel planning. Each active script in the current intent model is examined to determine if the action is an expected step in the execution of the script. If the action matches an event in an open segment of a script, the event is marked as completed and the operator action is explained. All active scripts are searched, even if a match is found early on, since a particular action may occur in more than one active script. When the script-based reasoner runs, it evaluates the termination conditions of each script to determine if any of the scripts should be removed from the current model of intent.

If the action is not predicted by the active scripts, then the system tries plan-based reasoning to explain the action in terms of a plan to satisfy one of the current goals of the operator. In order to do this, the system uses a knowledge base that incorporates domain knowledge and knowledge of the possible plans and goals of the user. The knowledge base is a relationship-based representation of the plan and goal graph for the given domain. The PGG represents goal-driven problem solving behaviors of the user. The relationships also define how scripts and user actions are related to the low level plans. Constraints are placed on the relationships to provide a way to account for the context in which the action occurred.

To explain a user action through plans, the system backward chains through its knowledge base to determine if the action was predicted by any of the current plans and goals of the user. This may require inferring intermediate plans and goals in order to connect the action to a higher level plan or goal that is already active. These new plans and goals will be invoked and incorporated into the current model of the user's intent. The intent interpreter 403 uses non-monotonic reasoning to update the model of the user's current intentions. As mentioned earlier, a side effect of inferring a new plan or goal may require revoking other plans and goals that are found to be inconsistent with the newly added plans and goals. Scripts may be activated or revoked by the inferencing of new plans as well. If the system is unable to explain the user's action either by scripts or plans, it is potentially an operational error by the user.Script performer 405 is used to execute multiple parallel situated scripts that are stored in knowledge base 406. As discussed above, these scripts are sequences of primitive actions whose execution is context sensitive. This component is a valuable tool in increasing the efficiency of the system to support real-time performance. The scripts can be thought of as a knowledge representation optimized for procedure execution; just as software executables can be viewed as optimized representations of source code.

The information manager 404 component of this embodiment of the present invention provides automatic information management features for the user interface. The information manager 404 uses knowledge stored in knowledge base 406 including the present intent of the user as determined by intent interpreter 403 to decide what information should be displayed to a user. Information needed by a user changes as the user's tasks and intentions change. This embodiment of the present invention uses a model to determine the information needed based on the current knowledge base.

One embodiment of the present invention uses an information manager 404 similar to that described in an article by B. W. Webb, N. D. Geddes, and L. O. Neste entitled “Information Management with a Hierarchical Display Generator.” This article describes an implementation of a system that selects and tailors the format of displayed information to the tasks being performed by a user.

Finally, knowledge base 406 stores all knowledge used in the client to conduct reasoning including plans, scripts, assertions, relationships, frames, etc. This component is analogous to the shared knowledge base 408 in the server system. Knowledge can be shared between the client and server systems using situation assessors 407 and 410 to maintain consistency and to communicate changes

The last component of this embodiment of the present invention is situation assessor 407. This component performs tasks analogous to those performed by situation assessor 410 on the server component of the present invention. Situation assessor 407 maintains the consistency of the knowledge base 406 as well as coordinating the sending and receiving of knowledge with server 409.

Situation assessor 407 maintains the consistency of the knowledge instances within the knowledge base 406 by identifying and resolving any inconsistent or outdated beliefs. In one embodiment of the present invention, the situation assessor uses a concept graph to update data values and beliefs. A concept graph is a knowledge representation of the dependencies between observable data values and higher-level computations and assertions made about the data.

In one embodiment of the present invention, the concept graph includes one or more means for calculating the degree of belief that the situation assessor 407 has in the values of each concept. One such means for calculating belief is Bayes Formula. When the situation assessor 407 receives new data, concepts that depend on that data are updated and their belief values are also updated. As a result of the updated belief values, the situation assessor 407 may reduce its belief in a concept, providing for non-monotonic truth maintenance for the situation assessor 407.

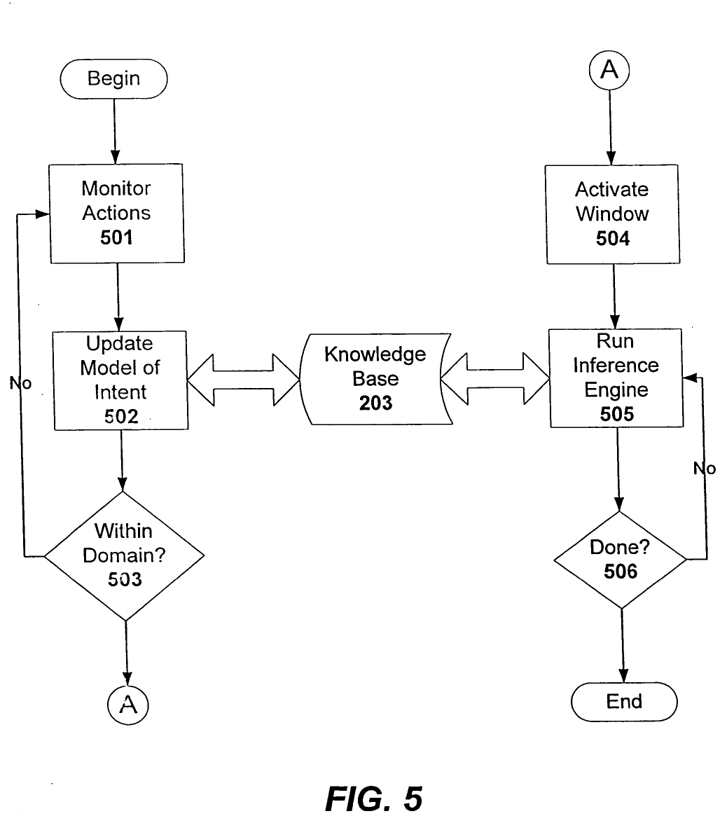

Using the architecture just described, the travel planning embodiment of the present invention operates as a plug-in to a web browser as discussed above. With reference to FIG. 5, the behavior of this embodiment of the present invention is described. The system begins by monitoring a user's behavior in block 501, using the intent interpreter 403 to determine what the user is most likely trying to accomplish. When a new action is received, the system then updates the intent model to reflect the new action as shown in block 502. The default assumption is that the user is simply surfing the web with no intention of performing any travel planning within the domain knowledge of the present invention. As shown in block 503, unless the most likely current intention of the user is within a domain of the system's knowledge, the system continues to monitor user actions in block 501.

When a user accesses a web site or series of web sites that indicate an intention within the travel planning domain, the system activates a window to communicate with the user as shown in block 504. In one embodiment of the present invention, this window is part of the browser window currently being used by a purchaser. In another embodiment of the present invention, the window is a pop-up window separate from the web browser.

In block 505, the system runs the inference engine, continually creating and refining plans until either the user is done, or until the user's intentions and goals change to some area outside of the system's domain knowledge. As shown in block 506, if the user is not done and his or her intentions are within the system's domain knowledge, the system will continue to run the inference engine in block 505.

While the inference engine is running in block 505, user interaction can be implemented in several different ways. For example, now that the user has completed his home improvement projects, he is ready for a vacation. The user logs onto the Internet and begins a search for a tropical destination. The system recognizes the user's intention after seeing the searches that he is performing and the web sites that he is visiting. A window pops up near the corner of the screen providing links to various information. As the user continues to surf the Internet, the links are updated to assist the user in carrying out his intentions. For example, when the user goes to a web site on Jamaica, the window is updated with information on Jamaica and on the Caribbean. As the system monitors the user's actions, it continually refines a model of the user's intentions so that the most useful information can be displayed as determined by the information manager. The user uses the links to plan a week long cruise to the Caribbean on a new cruise line.

The fourth embodiment of the present invention takes a more active approach. When the user returns from the vacation, he decides that it's time to start planning for next year's vacation. He logs onto the Internet and begins searching for something to do. The system recognizes his intentions and pops up a window. Instead of merely presenting passive links, this embodiment of the present actively communicates with the user. The system immediately asks the user how he liked his cruise. The user's responses are used to refine a model of his preferences.

In another embodiment of the present invention, the client software 401 works as a standalone plug-in to a browser with no interaction with server software 409. This embodiment uses a knowledge base 406 that is supplied with the system and updated based on interactions with the system. In still another embodiment, the client software 401 shares knowledge with the server software 409. For example, if several purchasers have a bad experience with a particular cruise line, then the system can alert the user of potential problems based on the knowledge gained from other users.

The following is a simplified illustrative embodiment showing the interactions between the various components of the inference engine. Consider an intelligent electronic purchasing support system to assist a human in goal-driven purchasing behaviors using an electronic commerce means such as the Internet. A typical field for goal driven purchasing is goods and services for home improvement projects. Other fields in which goal-oriented behaviors are common are travel and tour planning, vehicle maintenance, health and hygiene, and recreational sports and athletics.

The starting point for the planning cycle is the posting of a high-level goal instance from a plan-goal graph (PGG). The posting of a goal triggers a planning cycle that involves decomposing and specializing high-level goals into low-level actions that can be executed to achieve that goal. Each goal in the PGG has one or more child plans that represent alternatives, some of which can be executed directly and some that must be recursively decomposed into sub-goals and sub-plans and specialized until the primitive steps are reached. Because the planner is a least commitment planner, commitment to a specialization created during decomposition is limited to only those aspects of the plan for which commitment cannot be deferred. The planner maintains many feasible alternatives and does not down-select until necessary. If the system has been configured to interact closely with a human, candidate plans that are successfully decomposed and specialized may be proposed to the operator.

In addition to creating the decomposition of a plan into its sub-elements, the planner manages the specific life cycle states of each sub-element of a plan. The life cycle states, depicted in FIG. 6, provide the mechanism for managing the commitment of the system to the each of the plan sub-elements. Each of the life cycle states of a plan sub-element has specific monitoring knowledge associated with it, serving to focus the processing of the situation assessor and providing for an event-based control of the planner.

Throughout the life cycle of a PGG plan or goal, the dynamic planner maintains the parameters of the plan or goal and monitors for its success or failure. As a result, the planner can dynamically adjust plan parameters that mediate its execution and dynamically reselect and specialize children of a node as required.

The operation of the system begins in the situation assessor 407. In the simplest embodiments, this component monitors and reads inputs to the system. The situation assessor 407 uses the inputs it receives to add data to the knowledge base regarding the current state of the system. For example, in the present embodiment, the system monitors a user's key presses and mouse clicks to add facts or observations to the knowledge base 406. It may also collect data from other affiliated data systems, such as geographic information systems, product databases and catalogs, and from cooperating financial systems to update the situation of interest to the user.

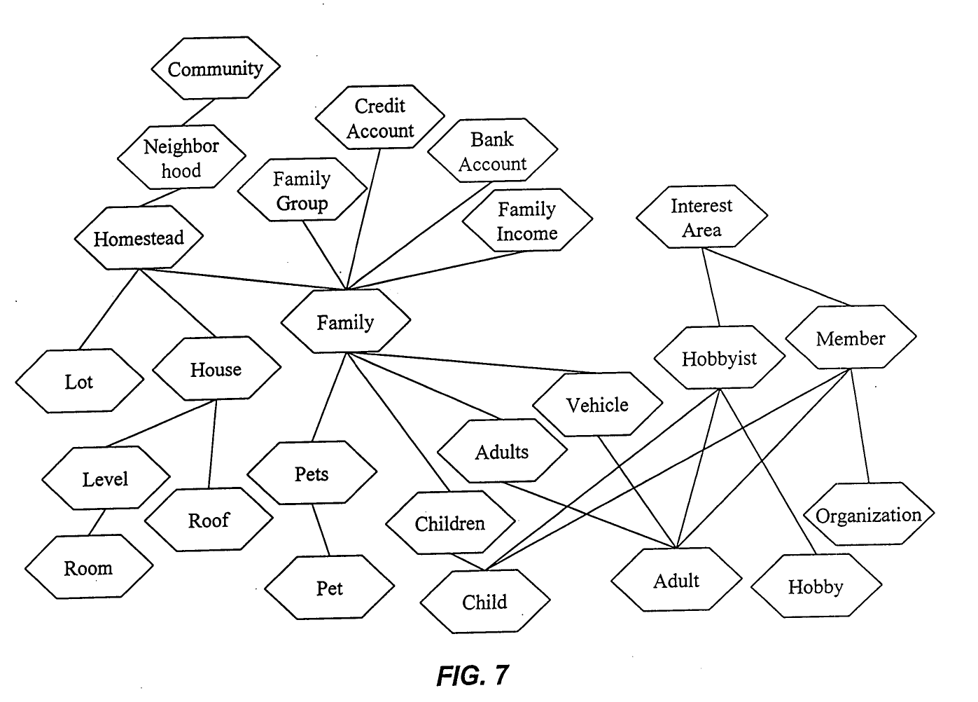

FIG. 7 shows a concept graph according to one embodiment of the present invention. The situation assessor 407 stores knowledge about the situations of possible interest in the knowledge base 406 in the form of a concept graph such as the one shown in FIG. 7. The concept graph specifies the relationships between lower level data and higher level concepts. The situation assessor 407 creates concept instances which represent specific data and conclusions that it determines based on its data inputs. The concepts may represent highly aggregated and abstract conclusions about the situation of the user and the user's lifestyle and environment. Each concept is capable of having monitors defined for it that can be activated by the planner 402 as the life cycle states of plans and goals change over time. For example, in FIG. 7, the concept graph shows the relationship between the concept of Family and the concepts of Pets, Adults, and Vehicles.

A monitor is a data input that can be defined by the system. Instead of monitoring all possible inputs at one time, embodiments of the present invention provide a mechanism for identifying what data is actually needed. A monitor corresponding to the needed data is then activated so that the needed data can be collected and used in the decision support process.

In this embodiment, the situation assessor 407 can also send and receive copies of concept patterns and instances by communicating with other cooperating electronic purchasing support systems also containing a situation assessor 407 and a knowledge base 406. The exchange of situation information is undertaken only when the users of the cooperating systems have explicitly agreed to share situation information. The communication may be achieved by a plurality of methods including local networks, direct connection and wide area networks such as the Internet.

Whenever a new fact is added to the knowledge base 406, the situation assessor 407 processes any monitors related to the new fact. If a monitor is found to be satisfied, an event is generated to the planner 402 that causes the planner to update its planning.

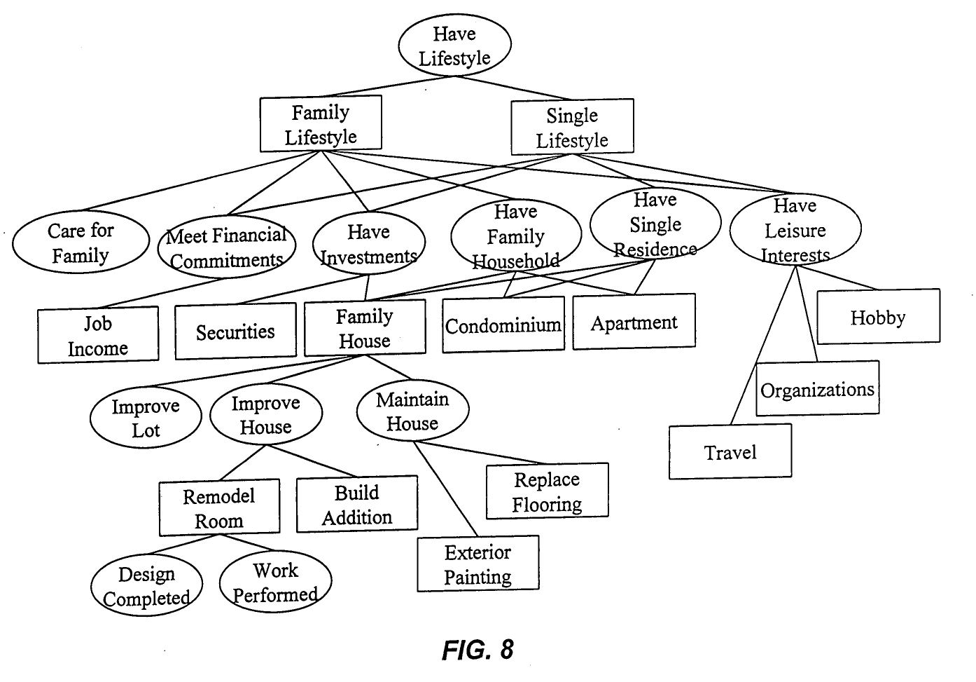

Whenever a new fact is added to the knowledge base 406 that represents the execution of a primitive action by the user, the intent interpreter 403 processes the new assertion to update a model of the current intent of the user. The intent interpreter uses a PGG model of user intentions such as the portion of the one shown in FIG. 8.

FIG. 8 shows a PGG model of user intentions. For example, the top-level goal is Have Lifestyle. This goal can be met using two different plans: (1) Family Lifesylte or (2) Single Lifestyle. In turn, these plans can be decomposed into goals such as Care for Family, Meet Financial Commitments, etc. These goals can, in turn, be decomposed into further plans and so on. A plan may also have a script for completing a plan associated with it or a goal may be fully decomposed into one or more primitive actions. The intent interpreter 403 searches through the system's PGG models of user intention to determine the possible and likely intentions of the current user. The intent interpreter 403 then instantiates one or more goals based on the current perceived intentions of the user.

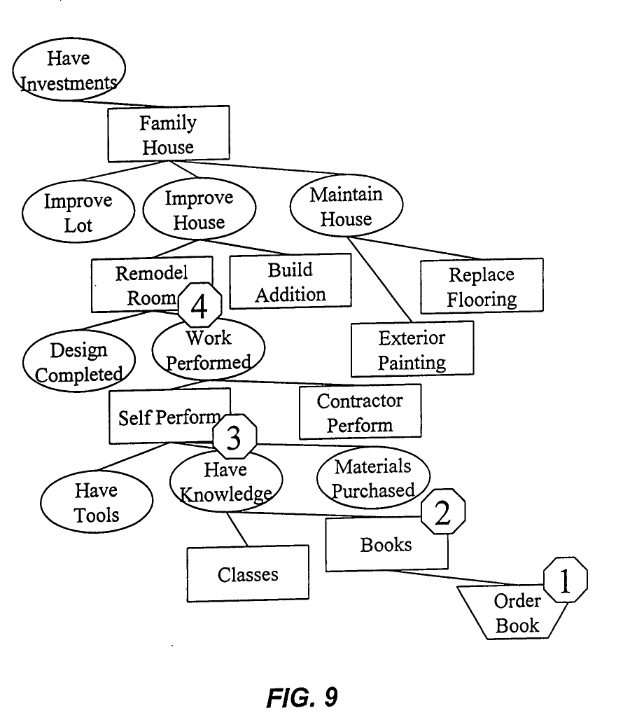

In FIG. 9, a user performs a primitive step or action at the user interface by placing an order request (1) with a specific supplier of books for a book on installing bathroom plumbing fixtures. The intent interpreter 403 searches for an explanation of this action, and finds in the knowledge base that the book is written for home improvement and that the user has not previously performed any bathroom plumbing projects. The intent interpreter 403 tentatively hypothesizes that the user plans to read a book about the plumbing tasks as the plan (2) for satisfying the goal to have knowledge about bathroom plumbing tasks (3). The intent interpreter 403 then searches for a higher level plan within the knowledge base 406 that explains the goal, and finds that there is an active plan for self-performing the plumbing removal and installation tasks as a part of an existing plan to remodel an existing bathroom in the user's family house (4). Hence, the intent interpreter 403 instantiates the plan (2) and the goal (3) within the knowledge base 406. The posting of the new goal starts the planner 402 to consider if there are more effective alternative plans for the goal, such signing up for the plumbing class at the local home improvement supply store.

The intent interpreter 403 uses non-monotonic reasoning in its search through the PGG knowledge in the knowledge base 406. If it is unable to find a complete path in the PGG from a hypothesized node to one known to be active, it can back up, retract its earlier assumptions and explore other paths.

In this embodiment, the intent interpreter 403 also sends and receives copies of plan and goal patterns and instances by communicating with other electronic purchasing support systems and supplier purchasing systems that contain an intent interpreter 403 and a knowledge base 406. The exchange of planning information is undertaken only when the user of the electronic purchasing support system has explicitly agreed to share planning information with other similarly equipped systems. The communication may be achieved by a plurality of methods, including local network, direct connection, and wide area networking such as the Internet.

Whenever a goal changes, or whenever a monitor event is received from the situation assessor 407, the planner 402 determines if any further planning needs to take place. For example, if the intent interpreter 403 instantiates a new goal, then the planner 402 needs to create a plan for achieving that goal. In the preferred embodiment, the planner 402 is a least commitment planner that performs a search of the PGGs stored in knowledge base 406 to determine subgoals and actions that need to be taken.

When goal instances and plan instances change life cycle state, the planner 402 uses knowledge in the knowledge base 406 to determine if any of the newly changed or updated goal or plan instances are in conflict with any other goal or plan instances. If a conflict is detected, the planner 402 sends a notification to the user interface.

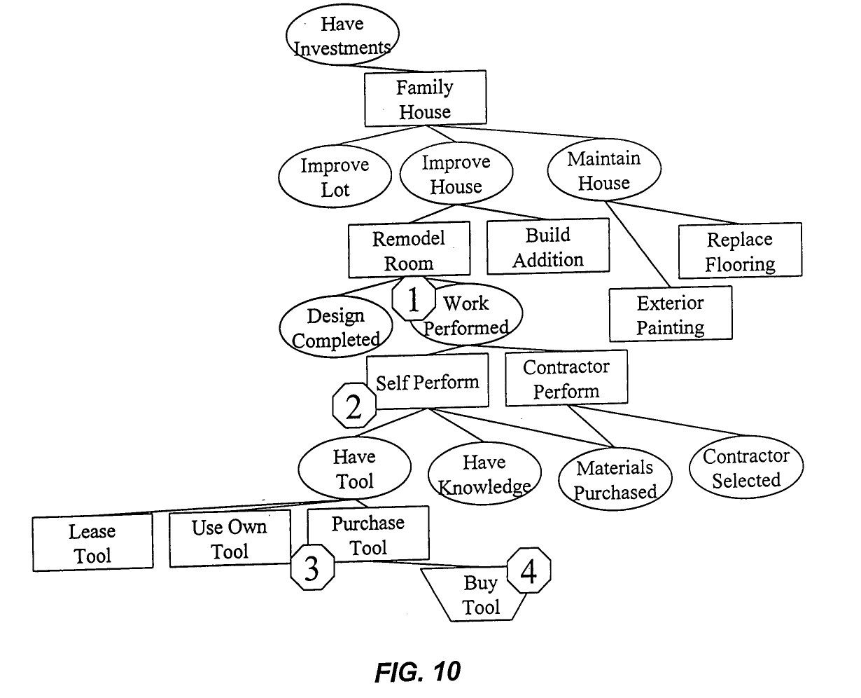

In FIG. 10, a user enters data defining the goal to have work performed (1) to repaint a bedroom as a part of remodeling the room. The planner 402 uses knowledge in the knowledge base 406 to determine that the room size and the user's past experience are appropriate for the user to perform the work, and considers the self perform plan (2). This plan has three subgoals, the first of which is to hove knowledge, the second of which is to have each of the needed tools, and the third is have the materials on hand. The planner 402 uses knowledge in the knowledge base 406 to determine that the tools should not be chosen until after the materials are selected, so reasoning about the tools is deferred until later. Once the materials are selected and ordered, a monitor is satisfied and the planner 402 can resume the solution of the tools goal. The planner 402 determines that purchasing a light duty airless power sprayer (3) will be more effective than leasing one, and that the user does not presently own this tool. The planner proposes this solution, leading to action (4) upon user acceptance of the proposal.

One optimization that is made in the present embodiment is the use of script performer 405. In a particular domain, many plans are commonly encountered and constitute a body of accepted methods known to practitioners within the domain. These plans can be implemented as scripts that represent partially specified procedures that can be executed without the need for extensive planning. The script performer 405 is a component of the present embodiment that facilitates the execution of scripts. These scripts are represented in the system's PGGs that are a part of the knowledge base 406. The script performer 405 can perform many and possibly all of the primitive actions that could be performed by a human user, but the script performer 405 is limited by a set of permissions provided by the human operator.

As an example, consider the goal of having a specific tool, and its child plan of leasing the tool from a particular leasing company, which may include scheduling the lease, arranging for delivery of the tool, and clearing the financial transaction. Because the process of obtaining a short term lease for a tool or machine is a well-defined and frequently recurring sequence of primitive actions, it can be represented as a script. The representation of the goal, its child plan, the script, and the relationship between the plan and the script are all a part of the knowledge base 406.

When a specific instance of the goal of having a tool is created, such as the goal for having a motorized ditching machine on Saturday, June 21, the planner 402 can create the instance of the plan to lease the ditching machine from Acme Rental. If the script performer 405 has been given permission, it can execute the script and automatically send the leasing notifications to the necessary involved parties.

The components described above provide a mechanism for assessing the current situation or state of system, planning one or more responses and executing the course of action. The information manager 404 is used to display information to a user or to update the user's display based on the current intentions or plans that have been identified by the planner 402 and the intent interpreter 403 using the knowledge base 406, the script performer 405, and the situation assessor 407.

For example, the knowledge base 406 contains a representation of the information that a human user would need to access if he was involved in a plan to pour a concrete patio in his back yard. One type of information relevant to a plan of this kind might be the weather conditions in the users region for the week before and after the planned installation. When an instance of such a plan is created, such a user in Greenville, S.C. scheduling a contractor to pour the concrete patio on April 10, the information manager 404 uses the attributes of the plan and the knowledge base 406 to determine that the weather in the Greenville region during the week before and after the scheduled work is of interest to the human. The information manager 404 then retrieves and requests the display presentations to show the weather forecast map for the correct region and time period. Additional information that is managed in this manner is pricing information on materials, supplies, tools and service providers relevant to each type of plan supported by the electronic purchasing support system.

The representative embodiments discussed above are given by way of example only. Conventional techniques of knowledge engineering can be used to create a knowledge base for any domain. Using the architecture discussed above with knowledge created for a particular domain, a system designer can create an intelligent agent to assist users in retrieving information, purchasing products, and obtaining services on the Internet.

By way of example, the embodiments discussed above were limited to the Internet. One of ordinary skill in the art will readily appreciate that the present invention can be used on any other communications network including, but not limited to the following: public or private voice networks, such as the Public Switch Telephone Network (PSTN) or Private Branch Exchanges (PBXs); public or private data networks, such as intranets, AOL™, or wireless networks; and public or private video networks.

Illustrative embodiments of the present invention have now been described. It will be appreciated that these examples are merely illustrative of the present invention. Many variations and modifications will be apparent to those of ordinary skill in the art.

1-28. (canceled)

29. A method for assisting a purchaser in conducting electronic commerce on a computer network, the method comprising:
in a computer network
determining a goal for a purchaser, the goal pertaining to a commerce domain; and
using a knowledge base to create one or more partial order plans to satisfy the determined goal, the knowledge base having embodied therein information pertaining to the domain of the goal.

30. The method of claim 29, wherein the plan incorporates a list of items necessary to carry out the determined goal.

31. The method of claim 29, wherein the act of creating a plan to satisfy the determined goal is performed using a least commitment partial order planner.

32. The method of claim 29, wherein the act of creating a plan to satisfy the determined goal is performed using a non-monotonic truth maintenance system.

33. The method of claim 29, wherein the knowledge base includes one or more plan and goal graphs.

34. The method of claim 29, wherein the knowledge base includes one or more concept graphs.

35. A buyer agent for conducting electronic commerce across a computer network, the buyer agent comprising:
in a computer network:
a knowledge base including information about one or more domains; and
an inference engine with access to the knowledge base;
wherein the inference engine uses the information in the knowledge base to create a plan for conducting electronic commerce.

36. The buyer agent of claim 35, wherein the knowledge base includes one or more plan goal graphs.

37. The buyer agent of claim 35, wherein the knowledge base includes one or more concept graphs.

38. The buyer agent of claim 37, wherein the inference engine includes a partial order planner and wherein the inference engine uses the partial order planner to create one or more plan instances.

39. The system of claim 38, wherein the inference engine manages life cycle states of the one or more plan instances according to a commitment level of the partial order planner.

40. The system of claim 39, wherein the inference engine manages monitoring of the situation using the one or more concept graphs according to the life cycle states of the one or more plan instances.

41. The system of claim 40, wherein the inference engine determines what further processing is needed by the partial order planner based on the monitoring of the situation.

42. The buyer agent of claim 35, wherein the knowledge base includes one or more scripts, each of the one or more scripts comprising a sequence of partially-specified primitive actions.

43. The buyer agent of claim 35, wherein the inference engine includes a partial order planner.

44. The buyer agent of claim 35, wherein the inference engine includes a non-monotonic truth maintenance system.

45. The buyer agent of claim 35, wherein the buyer agent is a Internet web browser plug-in.

46. The buyer agent of claim 45, wherein the buyer agent further includes a monitoring component, the monitoring component recording the actions of a user within the Internet web browser.

47. A method for assisting a purchaser in conducting electronic commerce on a computer network, the method comprising:
in a computer network
using an intent interpreter to determine a goal for a purchaser, the goal pertaining to a commerce domain; and
using a knowledge base to create one or more partial order plans to satisfy the determined goal, the knowledge base having embodied therein information pertaining to the domain of the goal.

48. The method of claim 47, wherein the plan incorporates a list of items necessary to carry out the determined goal.

49. The method of claim 47, wherein the act of creating a plan to satisfy the determined goal is performed using a partial order planner.

50. The method of claim 47, wherein the act of creating a plan to satisfy the determined goal is performed using a non-monotonic truth maintenance system.

51. The method of claim 47, wherein the knowledge base includes one or more plan and goal graphs.

52. The method of claim 47, wherein the knowledge base includes one or more concept graphs.

53. A buyer agent system comprising:
in a computer network, a plurality of intelligent agents, each of the plurality of intelligent agents including:
a knowledge base including information about one or more domains;
an inference engine with access to the knowledge base, the inference engine including a partial order planner;
a data management system that collects and distributes data; and
a graphical user interface system that displays information to a user.

54. The buyer agent system of claim 53, wherein the knowledge base includes one or more concept graphs.

55. The buyer agent system of claim 54, wherein each agent of the plurality of intelligent agents determines the intentions of one or more users and wherein the data management system of a first agent of the plurality of intelligent agents shares data with a second agent of the plurality of intelligent agents representing the determined intentions of the one or more users to facilitate collaboration.

56. The buyer agent system of claim 55, wherein the system uses the shared data to automatically detect conflicts between the one or more users.
